(19) United States
(12) Patent Application Publication
(10) Pub. No.: US 2011/0015973 A1
(43) Pub. Date: Jan. 20, 2011

(54) DISAGGREGATION AND ATTACHMENT OF CARBON CREDITS TO INDIVIDUAL ITEMS OF A SELLER THROUGH A UNIQUE IDENTIFIER

(76) Inventor: Antonio Benjamin, Fremont, CA (US)

Correspondence Address: Raj Abhyanker, P.C., 1580 West, El Camino Real, Suite 8, Mountain View, CA, 94040, US

(21) Appl. No.: 12/503,078

(22) Filed: Jul. 15, 2009

(51) Int. Cl. G06Q 30/00

(52) U.S. Cl. 705/14.1; 705/1.1; 705/319

(57) ABSTRACT

A method of an analysis server includes determining a set of attributes associated with a bundled inventory of carbon credits based on a meta-data provided along with the bundled inventory through the analysis server, and determining a source, a time of a creation and a geo-spatial location of each discrete unit of carbon credit of the bundled inventory through the set of attributes. The method also includes calculating a number of discrete units of carbon credit associated with an item of a seller based on a carbon footprint of the item, allocating the number of discrete units to the item, and generating a unique identifier of the item and allocated discrete units thereof such that no other item includes the same allocated discrete units.

### FIELD OF TECHNOLOGY

This disclosure relates generally to the technical fields of software and database technology, and more particularly to a system, method, and apparatus to enable a carbon credit marketplace.

### BACKGROUND

A corporation may wish to increase sales by providing incentives to potential customers. Potential customers may want to purchase items from entities they believe are environmentally conscious.

To attract potential customers, the corporation may wish to offset the environmental impact caused by the manufacturing, distribution, and marketing of goods and/or services. Providing enough information about environmental impact offsets allocated to a particular product or service being purchased may be impossible without proper accounting and analytics.

### SUMMARY

This Summary is provided to comply with 37 C.F.R. §1.73, requiring a summary of the invention briefly indicating the nature and substance of the invention. It is submitted with the understanding that it will not be used to interpret or limit the scope or meaning of the claims.

Several methods and system to implement an online carbon credit trading are disclosed.

An exemplary embodiment includes a method of an analysis server. The method includes determining a set of attributes associated with a bundled inventory of carbon credits based on a meta-data provided along with the bundled inventory through the analysis server. The method also includes determining through the set of attributes a source of each discrete unit of carbon credit of the bundled inventory, a time of a creation of each discrete unit of carbon credit of the bundled inventory, and a geo-spatial location of creation of each discrete unit of carbon credit. In addition, the method also includes calculating a number of discrete units of carbon credit associated with an item of a seller based on a carbon footprint of the item. The method further includes allocating the number of discrete units to the item. The method also includes generating a unique identifier of the item and its allocated discrete units such that no other item includes the same allocated discrete units.

An exemplary embodiment includes a method of a redemption server. The method includes exposing a social graph of a customer in a social community when the customer redeems an incentive of a seller through a unique identifier of an item and its allocated discrete units. The method also includes enhancing marketability of an item to at least part of the social community of the customer through the exposing of the social graph of the customers.

An exemplary embodiment includes a system. The system includes an analysis server to determine a set of attributes associated with a bundled credit. The analysis server also determines a source, time of creation and geo-spatial location of each discrete unit of carbon credit. The analysis server further calculates a number of discrete units of carbon credit associated with an item of a seller and allocates discrete units to the item, and generates a unique identifier for each item. In addition, the system includes a redemption server coupled to the analysis server to expose a social graph of a customer, and enhance the marketability of the item to at least part of a social community of the customer.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 illustrates a network system that brings carbon credit producers, carbon credit customers, social community networks, carbon credit sellers, and a system of communication through servers together, according to one embodiment.

FIG. 2 illustrates assignment of discrete carbon credit units and a unique identifier to an item using an analysis server, according to one embodiment.

FIG. 3 illustrates a system of enhancing carbon credit trade by marketing in a social graph of a social community of a carbon credit customer by collecting information from the carbon credit customer, according to one embodiment.

FIG. 4 is a process flow of generating a unique identifier for an item and generating a report to the carbon credit seller 130 having aggregate information related to the item, according to one embodiment.

FIG. 5 is a process flow of providing market analytics to the carbon credit seller 130 to enable the carbon credit seller 130 to meet marketing campaigns and goals 302, according to one embodiment.

Other features of the present embodiments will be apparent from the accompanying drawings and from the detailed description that follows.

### DETAILED DESCRIPTION

Several methods and a system to implement an online carbon credit trading are disclosed.

Although the present embodiments have been described with reference to specific example embodiments, it will be evident that various modifications and changes may be made to these embodiments without departing from the broader spirit and scope of the various embodiments.

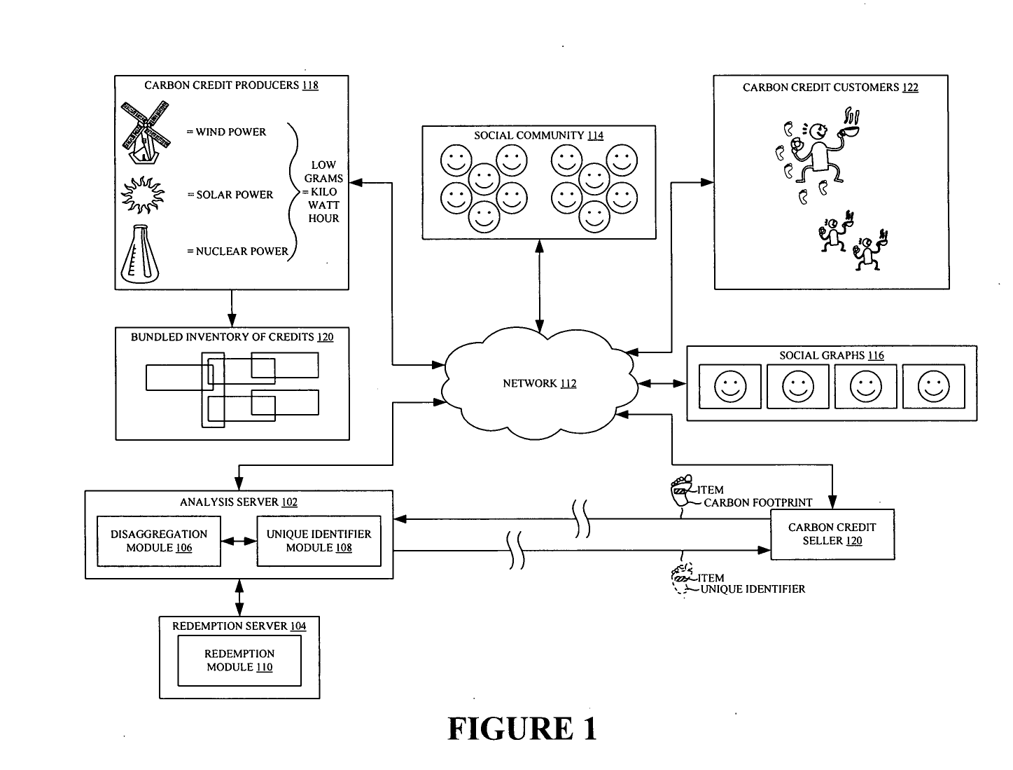

FIG. 1 illustrates a network system that brings carbon credit producers, carbon credit customers, social community networks, carbon credit sellers, and a system of communication through servers together, according to one embodiment. In particular, FIG. 1 illustrates an analysis server 102, a redemption server 104, a disaggregation module 106, a unique identifier module 108, a redemption module 110, a network 112, a social community 114, social graphs 116, carbon credit producers 118, bundled inventory of credits 120, a carbon credit customers 122, an item 124, a carbon footprint 126, a unique identifier 128, and a carbon credit seller 130, according to one embodiment.

There may be websites and organizations that help entities, customers and consumers to calculate their individual carbon footprint. The carbon footprint may be the amount of greenhouse gas emissions caused directly and indirectly by an individual, organization, event and/or product. The carbon footprint 126 may be calculated by giving an input about the product/purchased product to see their carbon footprint. The consumers, customers, and/or entities who may want to offset their carbon footprint may buy carbon credit from the carbon credit producer 118. The carbon credit producer 118 may be an entity, individual or an organization which produces renewable source of energy. The carbon credit producer 118 may have credits which may be purchased by the entities, consumers and customers. The carbon credit producer 118 may generate bundled inventory of carbon credits 120. The customer who wants to buy carbon credits from the carbon credit producer 118 may be called as the carbon credit customers 122.

The carbon credit customers 122 may include individuals, organizations, entities, industries, etc. The carbon credit customers 122 may purchase a product from the carbon credit seller 130 through a vendor entity. The vendor entity may unite the carbon credit producer 118, the carbon credit seller, the social community 114, and/or the carbon credit customers 122 online to enable one place for carbon credit trade. The vendor entity may manage the carbon credit trade using the analysis server 102 and the redemption server 104 through the network 112. The network 112 (e.g., LAN, WAN, internet) may enable communication among various entities, the carbon credit producers 118, the social community 114, the carbon credit seller 130, the analysis server 102, the redemption server 104, carbon credit customers 122, etc.

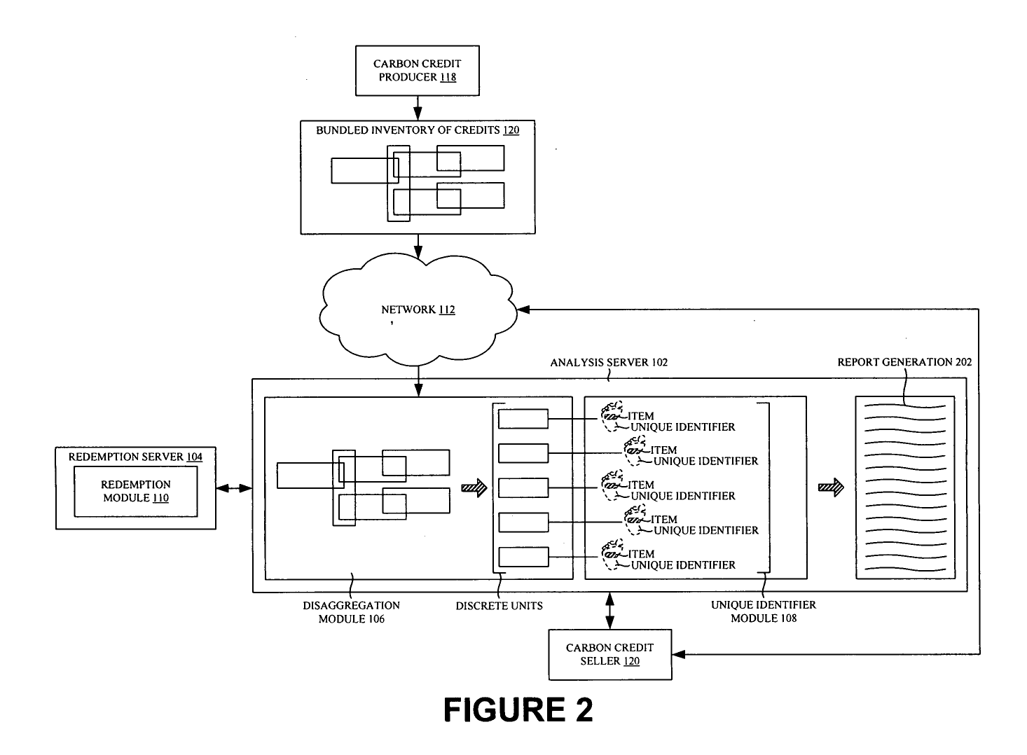

The analysis server 102 may determine a set of attributes associated with the bundled inventory of credits 120. In addition, the analysis server 102 may determine a source, time of creation and geo-spatial location of each discrete unit of carbon credit. The analysis server 102 may also calculate a number of discrete units of carbon credit associated with an item of the carbon credit seller 130 and allocates discrete units to the item 124. Furthermore, the analysis server 102 may generate a unique identifier 128 for each item. The analysis server 102 may also determine a set of attributes associated with a bundled inventory of carbon credits 120. Determination of the set of attributes associated with the bundled inventory of carbon credits 120 may be based on meta-data provided along with the bundled inventory of carbon credits 120. The set of attributes may include a source, a time of a creation and a geo-spatial location of each discrete unit of carbon credit of the bundled inventory of credits 120. The analysis server 102 may be better understood from the description of FIG. 2.

The item 124 may be a good and/or service of the carbon credit seller 130 that can be traded through the vendor (e.g., TrueCarbon, Inc.). Each item may have a carbon footprint and a unique identifier associated to that item. The carbon credit seller 130 may mention a carbon footprint for each of the item 124 that is uploaded in the analysis server 102. The disaggregation module 106 may disaggregate the bundled inventory of credits 120 into discrete units of carbon credits 204. The units may be denominated in both wholesale formats (e.g., sales of carbon credit units measured one ton or greater) and/or retail format (e.g., sales of carbon credit measured one ton or less like ounces, grams, kilos and pounds). Each carbon credit unit may be assigned a unique identifier by the analysis server 102. Each carbon item may be then associated to the item 124.

The analysis server 102 may assign a unique identifier for each product (e.g., for the carbon credit) using the unique identifier module 108. The carbon credit assigned may not be used again for another item. The redemption server 104 may expose the social graphs 116 of the carbon credit customers 122 to enhance the marketability of the item 124 to a part of the social community 114 of the carbon credit customers 122. The social graphs 116 of the carbon credit customers 122 may refer to mapping and relation with like-minded people or friends in the social community 114 that the carbon credit customers 122 has with respect to carbon credit. The social community 114 may be a community based networking that enables individuals to communicate with other people based on their interests and likeness. The redemption module 110 may inform the carbon credit customers 122 the source, the time, and the geo-spatial location associated with a carbon footprint of the item 124 through the unique identifier 128. The carbon credit customers 122 may redeem an incentive of the carbon credit seller 130 through the redemption module 110 of the redemption server 104.

The carbon credit seller 130 may communicate with the analysis server 102 for membership. The analysis server 102 may enable the carbon credit seller 130 to open an account via an interface where they are qualified and verified by an automated set of templates, questionnaires and/or other qualification methods. The carbon credit producer 118 may also be enabled by the analysis server 102. The carbon credit seller 130 upon approval from the analysis server 102 may upload their products for sale.

In an example embodiment, there may be a carbon credit customer John Doe who may wish to buy a product chocolate. John Doe may visit the carbon credit vendor to find the product chocolate from one or more carbon credit seller 130. John Doe may purchase the product chocolate which may have a unique identifier. John Doe may find out the carbon footprint of the product chocolate using the unique identifier on the product. John Doe may now want to offset the carbon footprint 126 caused by the product. John Doe may purchase some carbon credits from the carbon credit producer 118 through the vendor. In addition, John Doe may join a community in the social community 114 that likes the chocolate and is aware of the carbon footprint caused by the chocolate. The redemption module 110 with the permission of John Doe may communicate with the members of the community that likes the chocolate to enhance the sale of the product and carbon credits. The vendor may receive a definite portion of the consideration from the transaction between the carbon credit producer 118, the carbon credit seller 130 and the carbon credit customers 122, according to one embodiment.

FIG. 2 illustrates assignment of discrete carbon credit units and a unique identifier to an item using the analysis server 102, according to one embodiment. In particular, FIG. 2 illustrates the analysis server 102, the redemption server 104, the disaggregation module 106, the unique identifier module 108, the redemption module 110, the network 112, the carbon credit producer 118, the bundled inventory of credits 120, the items 124A-N, unique identifier 128A-N, the carbon credit seller 130, a report generator 202, and discrete units 204, according to one embodiment.

FIG. 2 may illustrate a functionality aspect of the analysis server 102 of FIG. 1. The bundled inventory of credits 120 generated by the carbon credit producer 118 may be disaggregated into discrete units 204 using the disaggregation module 106. The bundled inventory of credits 120 may be obtained from the carbon credit producer 118 through the network 112. The discrete unit generated by the disaggregation module 106 may be allocated to the item 124A-N of the carbon credit seller 130. The allocation of the discrete unit 204 to the item may be based on an algorithm determined through an analysis of clean energy power generation. The unique identifier module 108 may allocate a unique identifier to the item 124A-N. The carbon credit seller 130 may upload an inventory that may include multiple products. Each of the products may have a carbon footprint. The unique identifier module 108 may assign a unique identifier to each of the item 124A-N after discrete units 204 of carbon credits are assigned to an item.

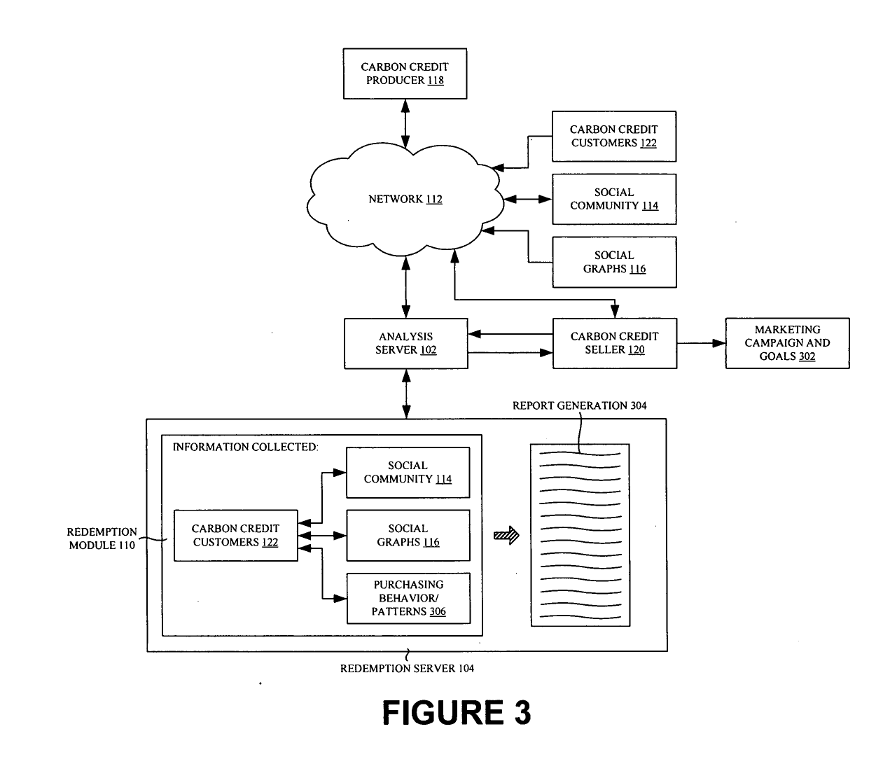

A report may be generated by the report generator 202 that includes aggregated information related to the item 124A-N based on the allocated number of discrete units 204 to the item 124A-N. The generated report may be communicated to the carbon credit seller 130. The redemption server 104 may be communicatively coupled to the analysis server 102. The redemption server 104 may be better understood from FIG. 3.

FIG. 3 illustrates a system of enhancing carbon credit trade by marketing in the social graphs 116 of the social community 114 of the carbon credit customers 122 by collecting information from the carbon credit customers 122, according to one embodiment.

In particular, FIG. 3 illustrates the analysis server 102, the redemption server 104, the redemption module 110, the network 112, the social community 114, the social graphs 116, the carbon credit producer 118, the carbon credit customers 122, the carbon credit seller 130, marketing campaign and goals 302, report generator 304, and purchasing behavior/patterns 306, according to one embodiment.

The redemption server 104 may be communicatively coupled to the analysis server 102. The redemption server 104 may include the redemption module 110. The redemption module 110 may inform the customer about the source, the time, and the geo-spatial location associated with the carbon footprint of the item 124 through the unique identifier 128. The redemption module 110 may also collect the information from the carbon credit customers 122 while redeeming the incentive. The carbon credit customers 122 may expose the social graphs 116 in the social community 114 while redeeming the incentive.

In addition, the redemption module 110 may keep records of the purchases made by the carbon credit customers 122. The records may be analyzed to understand purchasing behavior/patterns 306 of the carbon credit customers 122. Furthermore, the report generator 304 of the redemption module 110 may generate a report using the report generator 304 that describes the carbon credit customers 122 interests and likeness associated to certain products. The report may be utilized by the carbon credit seller 130 to further market items to the like minded individuals in the carbon credit customers 122 social graphs 116. The report may also help the carbon credit seller 130 to explore the options of selling other products to the carbon credit customers 122. Furthermore, the report may enable the carbon credit seller 130 to strategize their marketing campaign and goals 302.

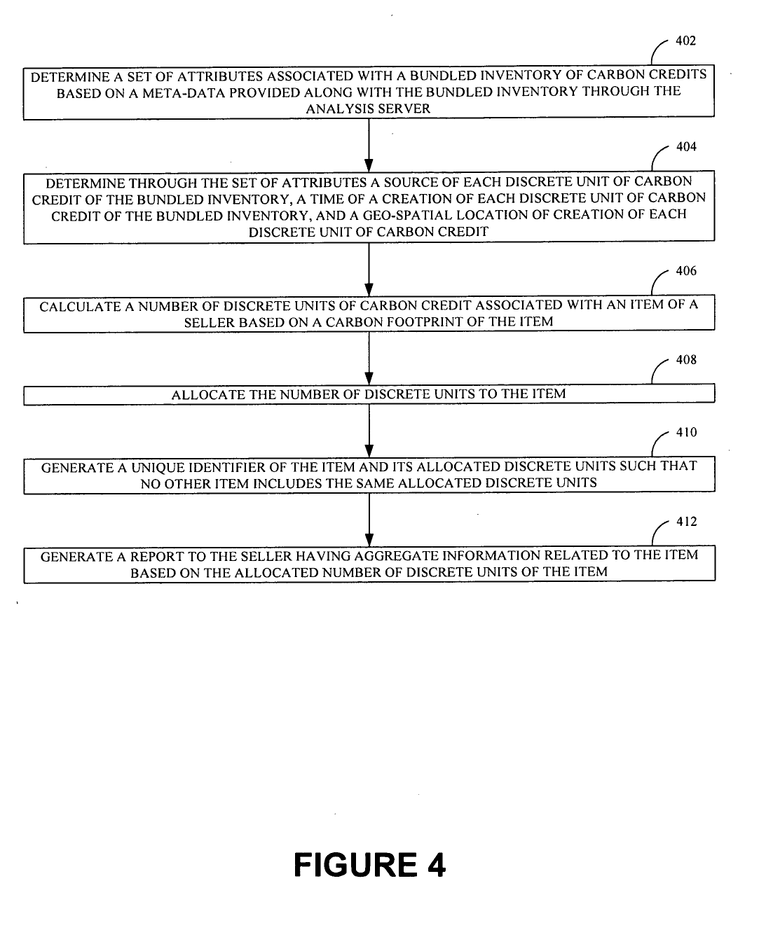

FIG. 4 is a process flow of generating an unique identifier for an item and generating a report to the carbon credit seller 130 having aggregate information related to the item, according to one embodiment.

In operation 402, a set of attributes associated with the bundled inventory of carbon credits 118 may be determined based on a meta-data provided along with the bundled inventory of credits 118 through the analysis server 102. For example, the analysis server 102 may be used to determine the set of attributes. In operation 404, the set of attributes may be determined through a source of each discrete unit of carbon credit of the bundled inventory. The set of attributes may also be determined by the time of a creation of each discrete unit of carbon credit of the bundled inventory, and a geo-spatial location of creation of each discrete unit of carbon credit. In operation 406, a number of discrete unit of carbon credit associated with an item of a seller may be calculated based on a carbon footprint of the item 124A-N (e.g., as illustrated in FIG. 2). In operation 408, the number of discrete units may be allocated to the item 124A-N. The number of discrete units may be allocated to the item 124 using the analysis server 102. In operation 410, a unique identifier of the item 124 and its allocated discrete units may be generated such that no other item includes the same allocated discrete units. For example, unique identifier module 108 may be used. In operation 412, a report to the carbon credit seller 130 having aggregate information may be generated related to the item 124 based on the allocated number of discrete units to the item 124.

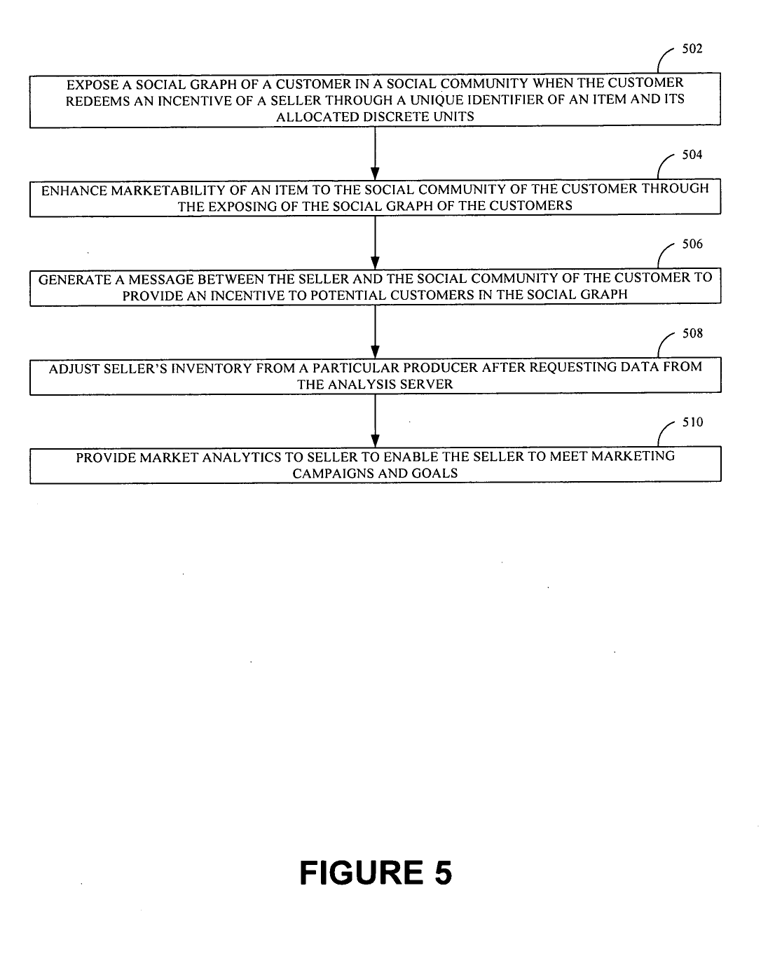

FIG. 5 is a process flow of providing market analytics to the carbon credit seller 130 to enable the carbon credit seller 130 to meet marketing campaigns and goals 302, according to one embodiment.

In operation 502, the social graphs 116 of the carbon credit customers 122 may be exposed in a social community 114 when the customer redeems an incentive of a seller through a unique identifier of an item and its allocated discrete units. For example, the redemption server 104 may be used to expose the social graphs 116. In operation 504, marketability of the item 124 may be enhanced to one or more part of the social community 114 of the customer through the exposing of the social graphs 116 of the customers. For example, the redemption server 104 coupled to the analysis server 102 may enhance the marketability of an item. In operation 506, a message may be generated between the carbon credit seller 130 and one or more part of the social community 114 of the customer to provide an incentive to potential customers in the social graphs 116. In operation 508, seller's inventory may be adjusted from a particular producer after requesting data from the analysis server 102. In operation 510, market analytics may be provided to seller to enable the carbon credit seller 130 to meet marketing campaigns and goals 302.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

Particularly, the analysis server 102, the redemption server 104, the disaggregation module 106, the unique identifier module 108, and the redemption module 110 may be enabled using software and/or using transistors, logic gates, and electrical circuits (e.g., application specific integrated ASIC circuitry) such as an analysis circuit, a redemption circuit, a disaggregation circuit, a unique identifier circuit, and a redemption circuit, and other circuit.

In addition, it will be appreciated that the various operations, processes, and methods disclosed herein may be embodied in a machine-readable medium and/or a machine accessible medium compatible with a data processing system (e.g., a computer system), and may be performed in any order (e.g., including using means for achieving the various operations). Accordingly, the specification and drawings are to be regarded in an illustrative rather than a restrictive sense.

What is claimed is:

1. A method of an analysis server comprising:
determining a set of attributes associated with a bundled inventory of carbon credits based on a meta-data provided along with the bundled inventory through the analysis server;
determining through the set of attributes a source, a time of a creation and a geo-spatial location of each discrete unit of carbon credit of the bundled inventory;
calculating a number of discrete units of carbon credit associated with an item of a seller based on a carbon footprint of the item;
allocating the number of discrete units to the item; and
generating a unique identifier of the item and allocated discrete units thereof such that no other item includes the same allocated discrete units.

2. The method of claim 1 wherein the discrete unit of carbon credit is based on an algorithm determined through an analysis of clean energy power generation.

3. The method claim 1 wherein the item is at least one of a good and a service marketed to customers of the seller.

4. The method of claim 1 wherein a customer purchases the item from the seller, and wherein the customer redeems an incentive of the seller through a redemption module which informs the customer of the source, the time, and the geo-spatial location associated with the carbon footprint of the item through the unique identifier.

5. The method of claim 4 wherein the customer exposes a social graph of the customer in a social community when redeeming the incentive, and wherein the social graph of the customer is utilized by the seller to further market items to at least part of the social community of the customer.

6. The method of claim 1 further comprising:
generating a report to the seller having aggregate information related to the item based on the allocated number of discrete units to the item.

7. The method of claim 1 in a form of a machine-readable medium embodying a set of instructions that, when executed by a machine, causes the machine to perform the method of claim 1.

8. A method of an redemption server comprising:
exposing a social graph of a customer in a social community when the customer redeems an incentive of a seller through a unique identifier of an item and allocated discrete units thereof; and
enhancing marketability of an item to at least part of the social community of the customer through the exposing of the social graph of the customers.

9. The method of claim 8 wherein the item is at least one of a good and a service marketed to customers of the seller.

10. The method of claim 8 further comprising generating a message between the seller and at least part of the social community of the customer to provide an incentive to potential customers in the social graph.

11. The method of claim 10 wherein the social graph of the customer further comprising determining that at least part of the social graph of the customer includes potential customers with similar purchasing patterns and behavior of the customer.

12. The method of claim 8 comprising adjusting seller's inventory from a particular producer after requesting data from an analysis server.

13. The method of claim 8 comprising providing market analytics to the seller to enable the seller to meet marketing campaigns and goals.

14. The method of claim 8 in a form of a machine-readable medium embodying a set of instructions that, when executed by a machine, causes the machine to perform the method of claim 8.

15. A system comprising:
an analysis server to determine a set of attributes associated with a bundled credit, determine a source, time of creation and geo-spatial location of each discrete unit of carbon credit, calculate a number of discrete units of carbon credit associated with an item of a seller, allocate discrete units to the item, and generate a unique identifier for each item; and
a redemption server coupled to the analysis server to expose a social graph of a customer, and enhance the marketability of the item to at least part of a social community of the customer.

16. The system of claim 15 further comprising:
a social community to communicate ideas among other members of the community and to provide the social graph of the customer in the social community.

17. The system of claim 15 wherein the discrete unit of carbon credit is based on an algorithm determined through an analysis of clean energy power generation.

18. The system claim 15 wherein the item is at least one of a good and a service marketed to customers of the seller.

19. The system of claim 15 wherein a customer purchases the item from the seller, and wherein the customer redeems an incentive of the seller through a redemption module which informs the customer of the source, the time, and the geo-spatial location associated with a carbon footprint of the item through the unique identifier.

20. The system of claim 19 wherein the customer exposes a social graph of the customer in the social community when redeeming the incentive, and wherein the social graph of the customer is utilized by the seller to further market items to at least part of the social community of the customer.
